(19) United States
(12) Patent Application Publication
(10) Pub. No.: US 2023/0177090 A1
(43) Pub. Date: Jun. 8, 2023

(54) SYSTEMS, METHODS, AND DEVICES FOR DYNAMIC RECORD FILTER CRITERIA FOR DATA OBJECTS OF COMPUTING PLATFORMS

(71) Applicant: Salesforce.com, Inc., San Francisco, CA (US)

(72) Inventors: Sindhubala ULAVAPALLI, San Francisco, CA (US); Alex YE, San Francisco, CA (US); Dai Duong DOAN, Alameda, CA (US); Puneet DHALIWAL, Dublin, CA (US); Tushar SHARMA, Concord, CA (US); Qian BAI, Pleasanton, CA (US); Shanis KURUNDRAYIL, Fremont, CA (US); Surya RAJAGOPAL, San Francisco, CA (US)

(73) Assignee: Salesforce.com, Inc., San Francisco, CA (US)

(21) Appl. No.: 17/457,359

(22) Filed: Dec. 2, 2021

(51) Int. Cl. G06F 16/906

(52) U.S. Cl. CPC G06F 16/906

(57) ABSTRACT

A computing platform is configurable to cause identifying a first data object type of a computing platform, the first data object type identifying first data objects being included in a data model of an application, and identifying a second data object type of the computing platform, the second data object type identifying second data objects included in the data model, and the identifying of the second data object type defining a relationship between the second data object type and the first data object type. The computing platform is also configurable to cause generating a filter rule associated with the second data object type, the filter rule defining which of the plurality of second data objects may be associated with the plurality of first data objects, the filter rule being defined based, at least in part, on at least some of a plurality of attributes of the second data object type.

### COPYRIGHT NOTICE

A portion of the disclosure of this patent document contains material which is subject to copyright protection. The copyright owner has no objection to the facsimile reproduction by anyone of the patent document or the patent disclosure as it appears in the United States Patent and Trademark Office patent file or records but otherwise reserves all copyright rights whatsoever.

### FIELD OF TECHNOLOGY

This patent document relates generally to on-demand computing platforms and more specifically to dynamic filtering of data objects of such computing platforms.

### BACKGROUND

“Cloud computing” services provide shared resources, applications, and information to computers and other devices upon request. In cloud computing environments, services can be provided by one or more servers accessible over the Internet rather than installing software locally on in-house computer systems. Users can interact with cloud computing services to undertake a wide range of tasks.

Cloud-based services may include software applications that include data models and data objects included in such data models. For example, on-demand software applications may be used to implement various process flows, and data objects may represent entities within such process flows. However, such applications remain limited in their ability to provide a user with the ability to manage relationships between such data objects.

### BRIEF DESCRIPTION OF THE DRAWINGS

The included drawings are for illustrative purposes and serve only to provide examples of possible structures and operations for the disclosed inventive systems, apparatus, methods and computer program products for filtering of data objects. These drawings in no way limit any changes in form and detail that may be made by one skilled in the art without departing from the spirit and scope of the disclosed implementations.

FIG. 1 illustrates an example of an arrangement of components in a data object filtering system, configured in accordance with one or more implementations.

FIG. 2 illustrates another example of an arrangement of components in a data object filtering system, configured in accordance with one or more implementations.

FIG. 3 illustrates an example of a method for data object filtering, performed in accordance with one or more implementations.

FIG. 4 illustrates another example of a method for data object filtering, performed in accordance with one or more implementations.

FIG. 5 illustrates yet another example of a method for data object filtering, performed in accordance with one or more implementations.

FIG. 6 illustrates an example of a method for data object querying, performed in accordance with one or more implementations.

FIG. 7 illustrates an image of an example of a data filtering tool, configured in accordance with some implementations.

FIG. 8 illustrates another image of an example of a data filtering tool, configured in accordance with some implementations.

FIG. 9 illustrates yet another image of an example of a data filtering tool, configured in accordance with some implementations.

FIG. 10 illustrates an additional image of an example of a data filtering tool, configured in accordance with some implementations.

FIG. 11 illustrates another image of an example of a data filtering tool, configured in accordance with some implementations.

FIG. 12 illustrates yet another image of an example of a data filtering tool, configured in accordance with some implementations.

FIG. 13 illustrates an additional image of an example of a data filtering tool, configured in accordance with some implementations.

FIG. 14 illustrates another image of an example of a data filtering tool, configured in accordance with some implementations.

FIG. 15 illustrates an additional image of an example of a data filtering tool, configured in accordance with some implementations.

FIG. 16 illustrates another image of an example of a data filtering tool, configured in accordance with some implementations.

FIG. 17 illustrates yet another image of an example of a data filtering tool, configured in accordance with some implementations.

FIG. 18 shows a block diagram of an example of an environment that includes an on-demand database service configured in accordance with some implementations.

FIG. 19A shows a system diagram of an example of architectural components of an on-demand database service environment, configured in accordance with some implementations.

FIG. 19B shows a system diagram further illustrating an example of architectural components of an on-demand database service environment, in accordance with some implementations.

FIG. 20 illustrates one example of a computing device, configured in accordance with one or more implementations.

### DETAILED DESCRIPTION

Cloud-based services may include software applications that are implemented in a distributed context. For example, an application may be deployed in multiple instances across multiple servers, and users may interact with the instances of the application. Such applications may utilize data models to define data objects that represent entities within the application. For example, data objects may be defined to represent particular entities within a work schedule for a work scheduling application. Accordingly, the data model may define generic data objects representative of such entities within a work schedule as well as dependencies between such data objects as part of a broader data model. Users may then utilize these data objects to implement various functionalities, such as work scheduling for a particular organization. As will be discussed in greater detail below, conventional software applications remain limited because they do not provide a user with the ability to define relationships between data objects to implement dynamic filtering between such data objects. Accordingly, conventional software applications remain limited in the functionality they provide users when implementing application functionalities, such as scheduling assets for a particular workflow.

Systems, methods, and devices disclosed herein provide users with the ability to dynamically determine filter criteria rules for different data object types in a data model of a software application. Accordingly, a user may be able to identify criteria of different data object types, as well as operators to be applied to those data object types, as may be applied during a query. Such filter criteria rules may be determined via a custom interface and may be stored in data objects specific to a user's account. In this way, a user may customize such filter criteria rules to generate a user-defined mapping between data objects in a data model. As will be discussed in greater detail below, such a user-defined mapping may improve the efficiency with which application functionalities, such as scheduling, are implemented.

In one example, a user may be provided with a user interface that enables the user to dynamically define multiple filter criteria rules between source data object types and filtered data object types. Accordingly, the user may provide inputs to the user interface to define filter criteria and operators for identified data object type pairs. The defined filter criteria rules may be stored as one or more data objects that may subsequently be used to execute queries. Accordingly, the user-defined rules and mapping between data objects may subsequently be used when such data objects of the data model are used by the software application.

For example, for a software application used for shift management of an organization, a user may utilize such a custom user interface to define a relationship between data object types in a data model for that shift management software application. More specifically, the user may define filter criteria and operators between shifts of workers and service appointments generated by the system. In this example, the user may define filter criteria associated with the service appointments such that only certain types of services appointments may be assigned to a shift. Accordingly, when the user subsequently uses the application to allocate resources to shifts, the custom filtering is applied within the application, and only matching service appointments are provided to the user.

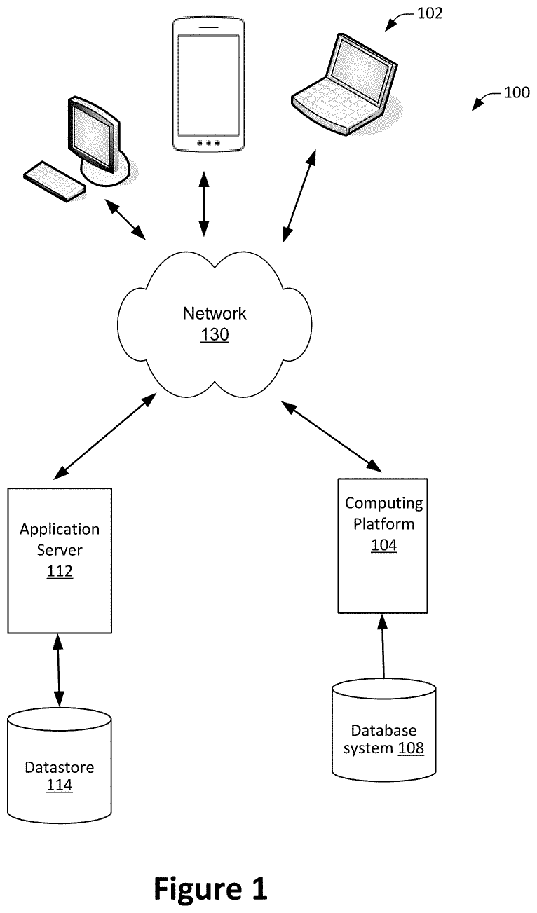

FIG. 1 illustrates an example of an arrangement of components in a data object filtering system, configured in accordance with one or more implementations. As will be discussed in greater detail below, a system, such as system 100, may be implemented to dynamically manage relationships between data objects in a distributed software application. Moreover, system 100 may also facilitate customization of such relationships. In this way, a user may customize and manage relationships between data objects in a data model, and such custom relationships may form the basis of data object filtering as may be applied during, for example, data object queries.

In some implementations, system 100 includes one or more client machines, which may also be referred to herein as client devices, such as client machine 102. In various implementations, client machine 102 is a computing device accessible by a user. For example, client machine 102 may be a desktop computer, a laptop computer, a mobile computing device such as a smartphone, or any other suitable computing device. Accordingly, client machine 102 includes one or more input and display devices, and is communicatively coupled to communications network 130, such as the internet. In various implementations, client machine 102 comprises one or more processors configured to execute one or more applications that may utilize a user interface. Thus, a user may request and view various different display screens associated with such applications via client machine 102. In various implementations, a user interface may be used to present the display screen to the user, as well as receive one or more inputs from the user. In some implementations, the user interface may utilize a web browser executed on client machine 102 or may be a standalone locally executed application. Moreover, such user interfaces may be used to access on-demand services and software applications, as will be discussed in greater detail below.

In various implementations, system 100 further includes one or more application servers, such as application server 112, and various client devices may be communicatively coupled to application server 112. In various implementations, application server 112 is configured to include software and hardware that provides an environment for the execution of an application. As will be discussed in greater detail below, the application may be a distributed application used to provide one or more on-demand services to users. As will be discussed in greater detail below, the application may include one or more data models that define classes of data objects, relationships between data objects, as well as parameters and fields associated with such data objects. For example, data objects may be defined to have specific data structures defined, at least in part, by specific data and metadata fields.

Application server 112 may include one or more processors and memory configured execute a software application, as discussed above. Accordingly, application server 112 may be configured to store program code and settings for a particular application, and may also be configured to execute the code. As discussed above, such program code may include application code and data objects included in a data model associated with the software application. In various implementations, application server 112 may be in communication with numerous client devices, and may implement the application in a distributed manner. In some implementations, application server 112 is further configured to generate and serve webpages that may be viewed by a user via one or more devices, such as client machine 102. Accordingly, application server 112 is configured to provide a web-based interface between a user of client machine 102 and an application that is deployed in a distributed environment. In various implementations, the application may also be configured to include an application interface that is configured to couple with one or more other entities, such as a computing platform discussed in greater detail below. In some implementations, application server 112 is coupled to datastore 114 which may be configured to store various application data and data associated with webpages served by application server 112, and thus may provide local storage for application server 112.

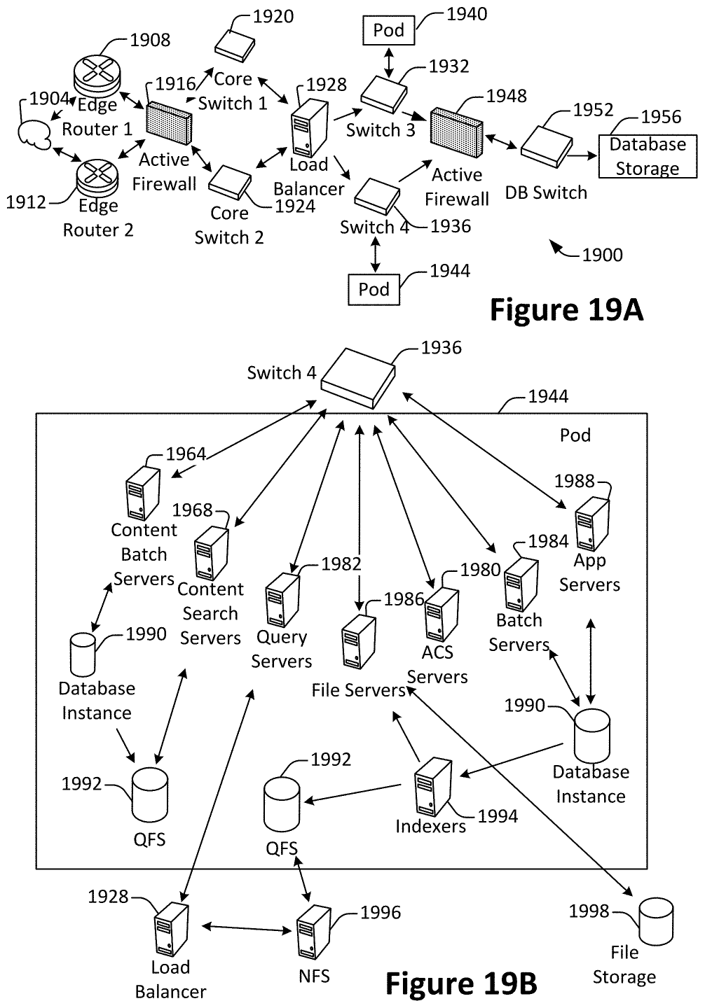

System 100 additionally includes computing platform 104. As shown in FIG. 1, computing platform may also be coupled to database system 108. As discussed in greater detail below with reference to at least FIG. 19, computing platform 104 is configured to host one or more distributed on-demand applications and/or host an on-demand computational environment, such as a software as a service (SaaS) platform. Moreover, computing platform 104 may also include an interface configured to handle function calls, also referred to herein as server calls, generated by application server 112. The interface may be implemented using components of a database system, such as an application program interface (API), discussed in greater detail below. Accordingly, various user data may be stored and maintained by components of computing platform 104. As also shown in FIG. 1, computing platform 104 is coupled to database system 108, which is configured to provide data storage utilized by computing platform 104. As will be discussed in greater detail below, database system 108 may be configured as a multi-tenant database system that provides storage of various user data for users for various different entities, such as subscribers of services provided by computing platform 104.

As will be discussed in greater detail below, one or more components of computing platform 104 may be configured to dynamically manage relationships between data objects within a data model of an application hosted by application server 112. More specifically, computing platform 104 may be configured to enable a dynamic mapping that defines which data objects can be associated with which other data objects within the data model, as well as defining parameters of that relationship. In this way, computing platform 104 is configured to provide a dynamic management of data record filtering that performed based on such relationships, and is additionally configured to enable customization of such management via a user interface provided to a user, as will be discussed in greater detail below.

While FIG. 1 illustrates application server 112 and computing platform 104 as being separate, it will be appreciated that they may be combined. For example, application server 112 may be a component included in computing platform 104. Accordingly, computing platform 104 may include various servers, and one or more of the servers may be application servers, such as application server 112.

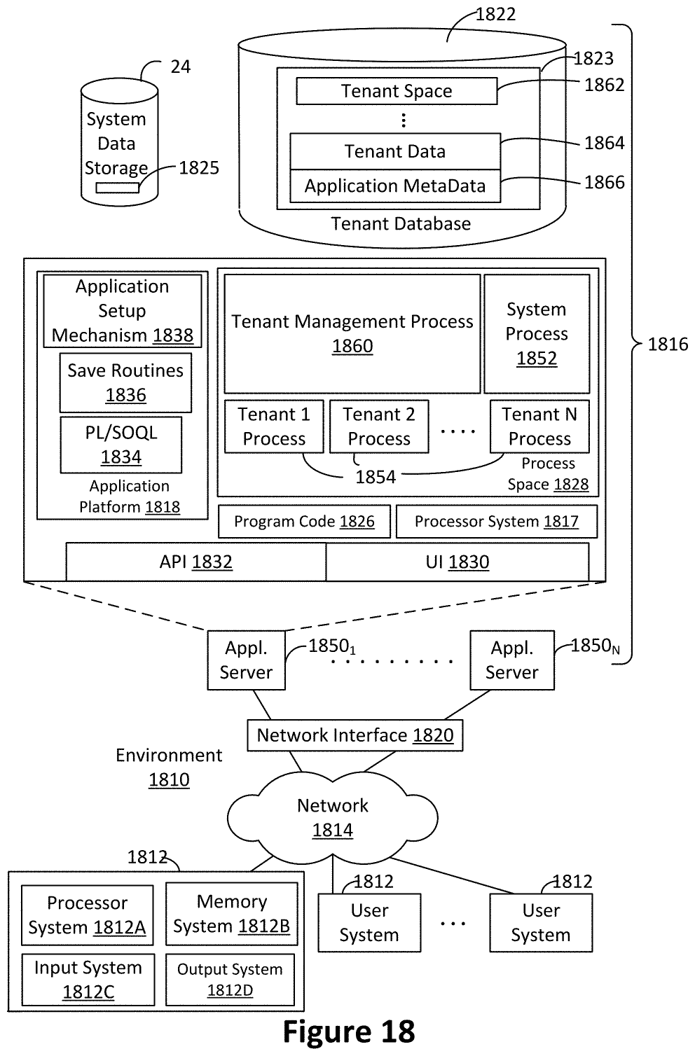

It will be appreciated that the data stored in database system 108 may include additional types of information as well, such as data from various knowledge databases, or any other suitable type of information maintained by an on-demand database service provider. The data stored in database system 108 may also be CRM data maintained by an on-demand database service provider, such as Salesforce.com®, and generated based, at least in part, on one or more services or products provided by the on-demand database service provider. In one example, the data stored in database system 108 may be social network data retrieved from one or more social networks such as Facebook® and LinkedIn®. Accordingly, database system 108 includes system data storage and a tenant database, as discussed in greater detail below with reference to FIG. 18. In various implementations, computing platform 104 is also coupled to network 130, and is communicatively coupled to application server 112 and client machine 102.

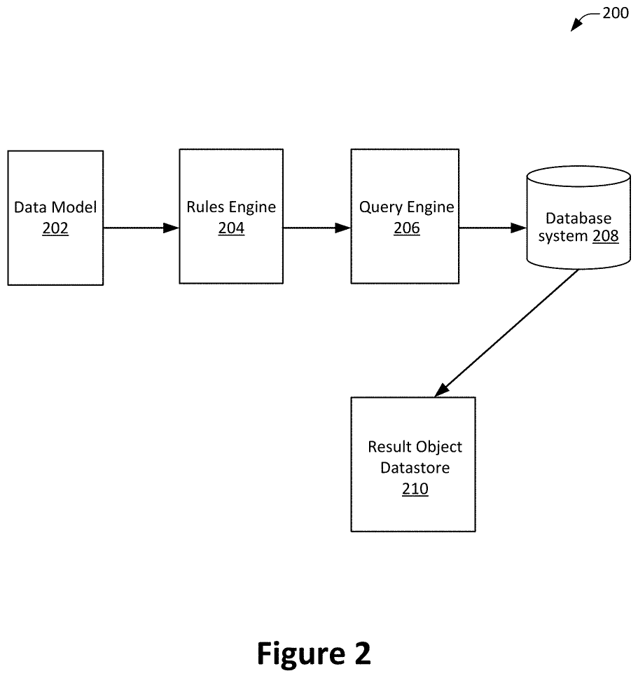

FIG. 2 illustrates another example of an arrangement of components in a data object filtering system, configured in accordance with one or more implementations. As similarly discussed above, a system, such as system 200, may be implemented to dynamically manage relationships between data objects in a distributed software application. As will be discussed in greater detail below, system 200 may also facilitate customization of such relationships. In this way, a user may customize and manage relationships between data objects in a data model, and such custom relationships may form the basis of data object filtering as may be applied during, for example, data object queries.

In various implementations, system 200 includes data model 202 which may be configured to define classes of data objects, relationships between data objects, as well as parameters and fields associated with such data objects. As similarly discussed above, data objects may be defined to have specific data structures defined, at least in part, by specific data and metadata fields. Accordingly, data model 202 may be stored in a storage device of an application server or a computing platform, or may be stored in a database such as a multi-tenant database system. In various embodiments, data model 202 may be generated based on application code of a distributed software application or a computational environment. For example, the software application may be a distributed application, such as customer relationship management platform provided by Salesforce.com®, and an underlying data model may include various different types of data objects used to manage such customer relationships. In one example, the data model may be included in a distributed scheduling application that may be used, for example, for scheduling activities and workflows of various entities. Accordingly, types of data objects included in such data models may be those representing entities such as “service appointment”, “service resource”, “maintenance asset”, and “shift”.

System 200 additionally includes rules engine 204 which is configured to manage one or more rules that may be applied to the data objects included in the data model. More specifically, one or more criteria data objects and rules data objects may be stored that define relationships between types of data objects included in a particular data model. For example, a criteria data object may include one or more data fields storing one or more data values representing a first data object type and a second data object type, as well as a type of relationship between the types of data objects. More specifically, the first data object type may be a source data object type, and the second data object type may be a filtered data object that is a target data object type. Moreover, the criteria data object may also identify a relationship between the two, such as Boolean indicator that indicates whether or not the two data object types should be associated with each other for queries, as will be discussed in greater detail below. In various implementations, rules data objects define filtering rules to be applied for such relationships. Accordingly, the filtering rules may place one or more constraints on which objects of a second data object type may be associated with which objects of a first data object type. Such filtering rules may be represented as operators, numerical ranges, timestamps, text strings, or symbols. Moreover, such filtering rules may be targeted and applied to specific data fields of data objects. Additional details regarding such criteria data objects and rules data objects are discussed in greater detail below.

System 200 further includes query engine 206 which is configured to execute queries of data objects included in data models based on the criteria data objects and rules data objects included in rules engine 204. Accordingly, query engine 206 is configured to execute such queries in a manner that identifies matching records based, at least in part, on filter criteria and rules specified in the criteria data objects and the rules data objects. More specifically, as will be discussed in greater detail below, given an input, query engine 206 may identify matching data objects based on the filter criteria and rules specified in the criteria data objects and the rules data objects. As will be discussed in greater detail below, query engine 206 may be included in, or may be communicatively coupled to, one or more components hosting a distributed application. Accordingly, query engine 206 may be configured to execute queries to identify and retrieve data objects used by the distributed application and in response to requests generated by the distributed application.

System 200 also includes database system 208 that is configured to store, among other things, application data. Accordingly, database system 208 may store various application data as well as other available data in a multitenant database system. Accordingly, application data as well as user data may be stored within database system 208, and such data may include data objects underlying the previously described data models. As will be discussed in greater detail below, the data stored in database system 208 may be queried by query engine 206.

System 200 also includes result object datastore 210 which is configured to store result objects returned based on queries of database system 208. Accordingly, one or more matching data objects may be returned as a result objects, and such a result object may be stored in result object datastore 210. In various implementations, result object datastore 210 may be a storage location of a computing platform, an application server, or may be a storage location of a client machine. Accordingly, a location of result object datastore 212 may be any suitable target storage location for the results of a query.

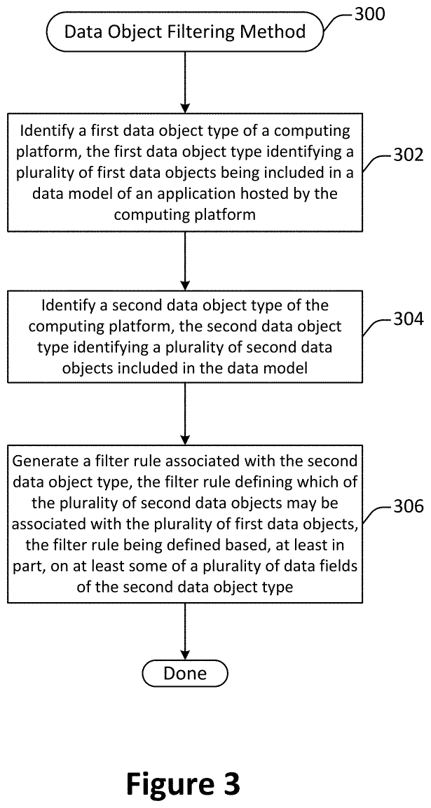

FIG. 3 illustrates an example of a method for data object filtering, performed in accordance with one or more implementations. As will be discussed in greater detail below, a method, such as method 300, may be performed to dynamically manage relationships between data objects in a distributed software application. Moreover, method 300 may also facilitate customization of such relationships. In this way, a user may customize and manage relationships between data objects in a data model, and such custom relationships may form the basis of data object filtering as may be applied during, for example, data object queries.

Method 300 may perform operation 302 during which a first data object type may be identified. In various implementations, the first data object type identifies a plurality of first data objects being included in a data model of an application hosted by the computing platform. As discussed above, the first data object type may be a source data object type that identifies source data objects that may form the basis of subsequent filtered queries. As will be discussed in greater detail below, the first data object type is identified by a user via an input that may be provided via a user interface.

Method 300 may perform operation 304 during which a second data object type may be identified. In various implementations, the second data object type identifies a plurality of second data objects including a plurality of data fields. As discussed above, the data fields may dependent on a data structure of the second data object type, as may be determined by a configuration of the data model. As also discussed above, the second data object type may be a filtered data object type upon which filtering rules will be applied. As will be discussed in greater detail below, the second data object type is also identified by a user via an input that may be provided via the user interface.

Method 300 may perform operation 306 during which a filter rule associated with the second data object type may be generated. In various implementations, the filter rule defines which of the plurality of second data objects may be associated with the plurality of first data objects. The filter rule may be defined based, at least in part, on at least some of the plurality data fields of the second data object type. Accordingly, a user may dynamically define permissible associations between source data objects and filtered data objects via a custom user interface. Additional details regarding such rule generation and user interface are discussed in greater detail below.

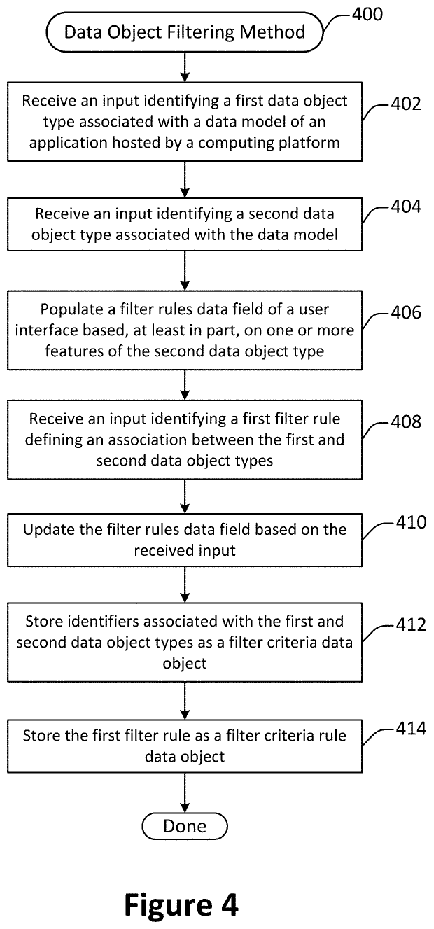

FIG. 4 illustrates another example of a method for data object filtering, performed in accordance with one or more implementations. As will be discussed in greater detail below, a method, such as method 400, may be performed to receive a user input that selects data object types and dynamically manages relationships between such selected data object types in a distributed software application. Accordingly, as will be discussed in greater detail below, method 400 may enable a user to dynamically configure, via a user interface, filter rules between different data object types of a data model, and store data objects representing such filter rules.

Method 400 may perform operation 402 during which an input may be received that identifies a first data object type associated with a data model of an application hosted by a computing platform. As similarly discussed above, the first data object type identifies a particular type of data objects being defined by and included in a data model of an application hosted by the computing platform. More specifically, and as will be discussed in greater detail below, the first data object type may be a source data object type that identifies source data objects that may form the basis of subsequent filtered queries. Accordingly, source data objects may form the basis of queries executed by a query engine to identify and return matching data objects.

As will also be discussed in greater detail below, according to various implementations, the first data object type is identified by a user via an input that may be provided via a user interface. More specifically, the user may provide an input to a user interface that identifies a particular type of source data object within the data model. The input may be provided via a data field that includes a drop-down menu, allows the entry of text, or receives any other suitable input. Additional details regarding the generation of such user interfaces and population of such data fields are discussed in greater detail below.

Method 400 may perform operation 404 during which an input may be received that identifies a second data object type associated with the data model. As similarly discussed above, the second data object type identifies a plurality of second data objects including a plurality of data fields. As discussed above, the data fields may dependent on and defined by a data structure of the second data object type, as may be determined by a configuration of the data model. More specifically, a data model may determine that a second data object type is to be configured to have a specific set of attributes stored in a specific configuration. As also discussed above, the second data object type may be a filtered data object type upon which filtering rules will be applied.

In various implementations, the second data object type is also identified by a user via an input that may be provided via the user interface. Accordingly, as similarly discussed above, the user may provide an input to a user interface that identifies a particular type of filtered data object within the data model for which a relationship with the source data object type is to be defined. As similarly discussed above, the input may be provided via a data field that includes a drop-down menu, allows the entry of text, or receives any other suitable input. As will be discussed in greater detail below, the contents of such drop-down menus or other input data fields may be populated, at least in part, based on the first data object type that was identified. For example, dependencies between data objects within the data model may be used for such auto-population. Additional details regarding the generation of such user interfaces and population of such data fields are discussed in greater detail below.

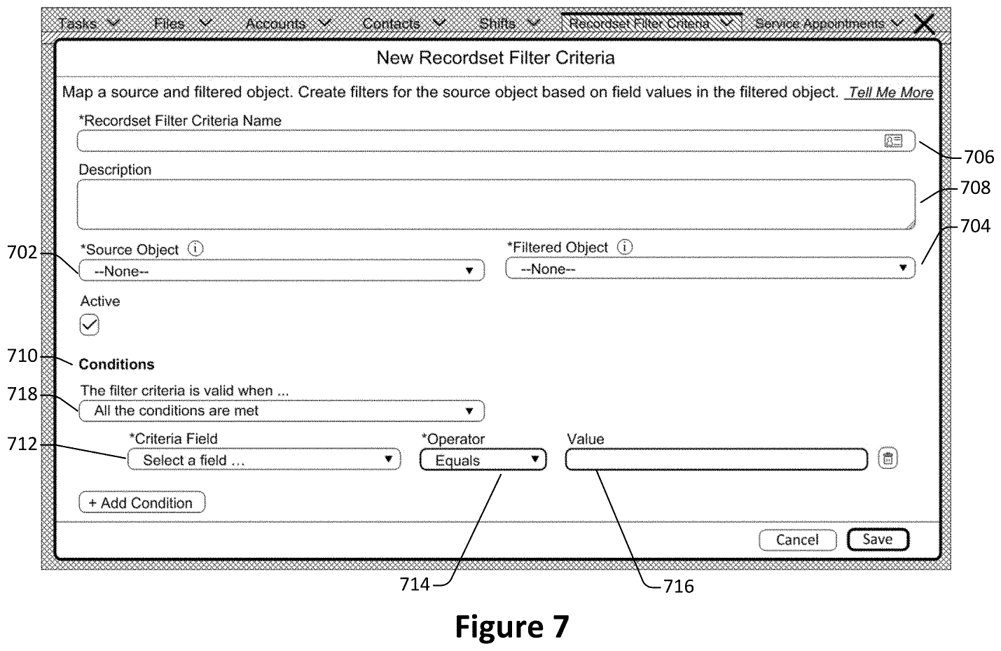

Method 400 may perform operation 406 during which a filter rules data field of a user interface may be populated based, at least in part, on one or more features of the second data object type. In various implementations, the filter rules data field of the user interface includes one or more data fields configured to receive user inputs identifying filter criteria underlying a filter rule to be applied for the first and second data object types. Accordingly, the filter rules data field may be configured to display one or more possible rules that may be available and may be candidates for selection by the user. Thus, during operation 406, such candidates may be auto-populated based on the selected first and second data object types. In one example, auto-population of such candidate selections may be implemented based on attribute data fields of the selected data objects. Thus, attributes of such data objects as may be identified as candidate filter criteria. Additional details regarding such data fields are discussed in greater detail with reference to at least FIGS. 7-17.

Method 400 may perform operation 408 during which an input may be received that identifies a first filter rule defining an association between the first and second data object types. As similarly discussed above, the filter rule defines which of the plurality of second data objects may be associated with the plurality of first data objects. Accordingly, during operation 408, the user may select particular filter criteria and filter operators to be applied to the first and second data object type.

Method 400 may perform operation 410 during which the filter rules data field may be updated based on the received input. In various implementations, the filter rules data field may be updated to include an additional input data field that may be configured to receive an additional input defining an additional filter rule. In this way, multiple different filter rules may be specific for a single identified data object type pairing. Additional details regarding such updating of filter rules data fields are discussed in greater detail with reference to at least FIGS. 7-17.

Method 400 may perform operation 412 during which identifiers associated with the first and second data object types may be stored as a filter criteria data object. In various implementations, the filter criteria data object includes data fields configured to store identifiers representing the selected first and second data object types identified during operation 402 and 404. The identifiers may be determined based on native identifiers used by the underlying data model. The filter criteria data object may also store one or more other identifiers, such as an identifier that specifies whether or not a filter rule is active. The filter criteria data object may also store other data, such as contextual text information provided by a user at the time of creation of the filter rule.

Method 400 may perform operation 414 during which the first filter rule may be stored as a filter criteria rule data object. In various implementations, the filter criteria rule data object includes one or more data fields configured to store data values, such as identifiers that represent filter criteria that have been selected for a particular filter rule. For example, the identifiers may represent filter criteria such as particular operators and match conditions, as well as particular attributes of the data object types for which such operators and/or match conditions are specified.

In various implementations, the filter criteria rule data object is stored as a dependent or child data object of its underlying filter criteria data object. Accordingly, the filter criteria rule data object may be stored with dependency information, and may be associated with or used by one or more other filter criteria data object. In this way, identifications of relationships between first and second data object types may be stored separately from identification of filter criteria underlying the identified relationships, and dependency information may be maintained. It will be appreciated that while the filter criteria data object and the filter criteria rule data object are discussed as being stored separately, in some implementations, their underlying information may be stored in the same data object.

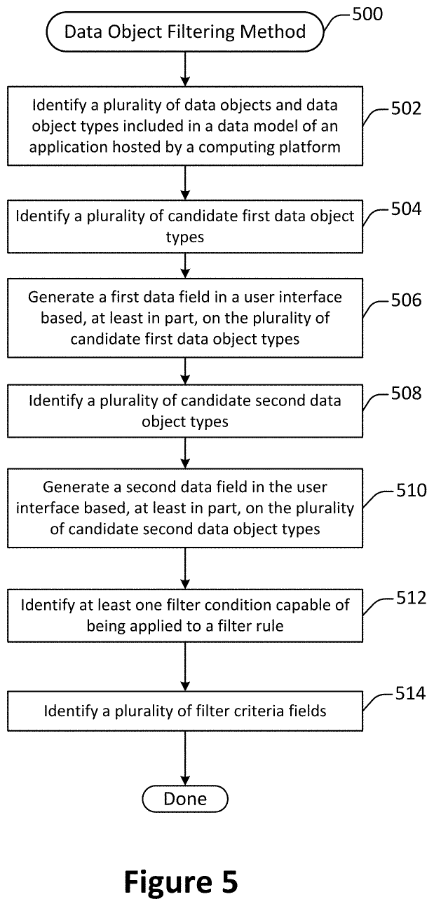

FIG. 5 illustrates yet another example of a method for data object filtering, performed in accordance with one or more implementations. As will be discussed in greater detail below, a method, such as method 500, may be performed to generate a user interface that is configured to receive a user input to select data object types and dynamically manage relationships between such selected data object types in a distributed software application. Accordingly, as will be discussed in greater detail below, method 500 may utilize underlying data of a data model to configure and generate input fields provided to a user.

Method 500 may perform operation 502 during which a plurality of data objects and data object types included in a data model of an application hosted by a computing platform may be identified. Accordingly, during operation 502, information about the data model may be retrieved. Such information may include a list of data object types defined for the data model, as may be specified by one or more portions of the application code deployed for a particular instance of a distributed application. As similarly discussed above, such data object types may correspond to different entities within the data model used to implement an aspect of an on-demand service. For example, the data model may include various data object types for entities included in scheduling or workflow management. More specifically, for an on-demand service used for allocation of assets for maintenance and service operations, different data object types may be used to represent entities, such as “service appointments” and “shifts” for workers to be scheduled. Such data types may be identified as part of the underlying data model, and such information may be retrieved during operation 502.

Method 500 may perform operation 504 during which a plurality of candidate first data object types may be identified. In various embodiments, the candidate first data object types are candidate source object types that may be selected by a user. Accordingly, while no selection has yet been provided by a user, a list of possible candidate selections may be automatically populated based on the information retrieved from the data model during operation 502. In various embodiments, the candidate first data object types may be the list of data object types retrieved during operation 502. In some implementations, the candidate first data object types may be a filtered version of the list, where one or more constraints are applied to the retrieved list. For example, the list may be filtered based on a role or level of user-access of the user for which the user interface is generated.

Method 500 may perform operation 506 during which a first data field in a user interface may be generated based, at least in part, on the plurality of candidate first data object types. As similarly discussed above, the first data field may be configured to receive an input from the user that identifies a first data object type that may be a source data object type. Accordingly, the first data field may be configured to receive a text input, or may be generated such that it displays at least some of the candidate first data object types. For example, the first data field may be a drop-down menu displaying multiple data object types from the identified candidate first data object types.

Method 500 may perform operation 508 during which a plurality of candidate second data object types may be identified. In various implementations, the candidate second data object types are candidate filter object types that may be selected by a user. Accordingly, while no selection has yet been provided by a user, a list of possible candidate selections may be automatically populated based on the information retrieved from the data model during operation 502, and also based on the identified candidate first data object types.

In various implementations, the candidate second data object types may also be identified based on the list of data object types retrieved during operation 502. Moreover, the candidate second data object types may also be filtered based on one or more constraints such as a role or level of user-access of the user for which the user interface is generated. In various implementations, the candidate second data object types may be identified based, at least in part, on dependency information associated with the candidate first data object types. For example, child data objects of the candidate first data object types or otherwise related data object types may be identified and prioritized in the identified candidate second data object types.

Method 500 may perform operation 510 during which a second data field may be generated in the user interface based, at least in part, on the plurality of candidate second data object types. As similarly discussed above, the second data field may be configured to receive an input from the user that identifies a second data object type that may be a filtered data object type. Accordingly, the second data field may be configured to receive a text input, or may be generated such that it displays at least some of the candidate second data object types. For example, the second data field may be a drop-down menu displaying multiple data object types from the identified candidate second data object types.

Method 500 may perform operation 512 during which at least one filter condition capable of being applied to a filter rule may be identified. In various embodiments, the filter condition may be a descriptor of a type of filtering to be applied. For example, the filter condition may be a logical operator indicating that data fields must match. Accordingly, such logical operators may define, at least in part, matching conditions of a filter rule. Thus, filter conditions may be identified that may be logical operators, and associated user interface elements may also be identified, such as a graphical representation of “must contain exact match”. In various implementations, the identified filter conditions may also be displayed in a data field of the user interface, such as the filter rules data field discussed above.

Method 500 may perform operation 514 during which a plurality of filter criteria fields may be identified. As similarly discussed above, such filter criteria may be determined based on attributes of data objects. Accordingly, the filter criteria fields may be populated based on attributes of the candidate first and second data object types discussed above. More specially, the attribute data fields of such data objects, as determined by the data structure of the underlying data model, may be identified as filter criteria fields and used to generate corresponding user interface elements, as discussed in greater detail below. In various implementations, the identified filter criteria fields may also be displayed in a data field of the user interface, such as the filter rules data field discussed above. Additional details regarding such filter criteria fields are discussed in greater detail below with reference to FIGS. 7-17.

It will be appreciated that various aspects of the operations discussed above may be configured based one or more aspects of a distributed application, or other aspects of a multitenant database system. For example, a user's role or identity within an organization may be used to customize the generation of a user interface and corresponding data fields discussed above. More specifically, if a user has a particular role within the organization, the user may also have particular security parameters identifying a security level of access to information stored in the multitenant database system. Accordingly, candidate data object types and candidate data objects may be filtered and/or masked based on such security parameters. In this way, the generation of the user interface may be contextual, and may be implemented in a manner determined based on one or more parameters of the user, such as the user's role within an organization. It will be appreciated that the generation of the user interface may be implemented in a manner determined based on other parameters as well, such as parameters of the data objects themselves which may be global security parameters defined for particular types of data objects.

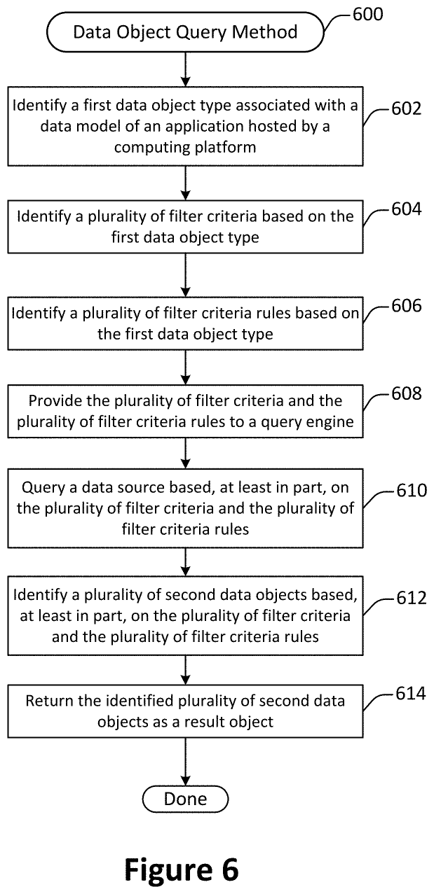

FIG. 6 illustrates an example of a method for data object querying, performed in accordance with one or more implementations. As will be discussed in greater detail below, a method, such as method 600, may be performed to implement queries based on the filter rules discussed above. Accordingly, as will be discussed in greater detail below, method 600 may utilize filter rules specified by the user to implement customized queries of data objects in the data model, and to provide a result object that includes matching data records.

Method 600 may perform operation 602 during which a first data object type associated with a data model of an application hosted by a computing platform is identified. As discussed above, the first data object type may be a source data object type specified by a user when a query is requested. In some implementations, the first data object type may be identified based on an input received from another system component, such as a request from a component of the computing platform or application server. In this way, system events or user input may trigger the query.

In various implementations, the request may be a request from a component of a distributed application hosted by an application server and/or a computing platform. Accordingly, a request for the query may be generated by a component of a distributed application, and the query may be performed to implement a distributed application function. Accordingly, as will be discussed in greater detail below, the user-defined mapping and filter criteria may incorporated in underlying functionality of such distributed applications by dynamically defining relationships between data objects used to serve application requests.

Method 600 may perform operation 604 during which a plurality of filter criteria is identified based on the first data object type. Accordingly, based on the first data object type, one or more filter criteria data objects may be identified and retrieved. As similarly discussed above, such filter criteria data objects may include identifiers for associated data object types, and may thus be identified based on these identifiers.

Method 600 may perform operation 606 during which a plurality of filter criteria rules is identified based on the first data object type. Accordingly, based on the first data object type as well as the filter criteria data objects, one or more filter criteria rule data objects may be identified and retrieved. As similarly discussed above, such filter criteria rule data objects may have dependencies defined for particular filter criteria data objects. Accordingly, during operation 606, the filter criteria rule data objects may be identified based on such dependency information.

Method 600 may perform operation 608 during which the plurality of filter criteria and the plurality of filter criteria rules are provided to a query engine. Accordingly, the information identified and retrieved from operations 604 and 606 may be provided to the query engine and may be used as to customize the implementation of the query. More specifically, as will be discussed in greater detail below, the query engine may use the filter criteria and filter criteria rules to filter query results based on the filter rules.

Method 600 may perform operation 610 during which a data source may be queried based, at least in part, on the plurality of filter criteria and the plurality of filter criteria rules. As discussed above, the data source, which may be a database system of an on-demand service provider, may be a multi-tenant database that stores application data and user data. Accordingly, data objects underlying the data model may be stored in such a database system. During operation 610, the query engine may query the data objects in the database system, and may analyze attribute fields of the data objects based on the specified filter criteria rules to determine which data objects satisfy the query.

Method 600 may perform operation 612 during which a plurality of second data objects may be identified based, at least in part, on the plurality of filter criteria and the plurality of filter criteria rules. Accordingly, second data objects that satisfy the filtering criteria and rules specified during operation 604 and 606 may be identified by the query engine by matching data objects, and may be identified as results of the query.

Method 600 may perform operation 614 during which the identified plurality of second data objects may be returned as a result object. Accordingly, the results of the query may be included in a data object, such as a result object. Moreover, the result object may be stored in the database system, or may be stored in a dedicated storage location for custom user queries. In some implementations, the result object may be transmitted to an entity, such as an application server or a client machine. Accordingly, the result object may be automatically provided to a target location.

In various implementations, the result object may be included as a response to a request from a distributed application. Accordingly, the result object may be a data object that is used by the distributed application, and the data object may be configured based on a data model of the distributed application. More specifically, the result object may provide results of the query in a data object specifically configured to be integrated with one or more operations of the distributed application. For example, in a distributed application used for scheduling and workflow management, the result object may be configured to provide results for resource and asset allocation in a data object having a data structure configured in accordance with the data model underlying the scheduling and workflow management features of the distributed application. Thus, the result object may be presented as one or more native data objects of the distributed application. In this way, the results of the query may be generated based on the user-defined filtering and mapping, and seamlessly integrated with operation of the distributed application.

FIG. 7 illustrates an image of an example of a data filtering tool, configured in accordance with some implementations. As discussed above, a user interface, such as user interface 700, may be generated and presented to a user to receive one or more inputs used to generate filter criteria data objects and filter criteria rule data objects. Accordingly, user interface 700 may include one or more user interface elements such as first data field 702 which is configured to receive an input identifying a first data object type, which may be a source data object type. Moreover, user interface 700 may include second data field 704 which is configured to receive an input identifying a second data object type, which may be a filtered data object type. User interface 700 may also include additional elements, such as third data field 706 and fourth data field 708 which are configured to receive, respectively, a descriptive name for the filtering rule that is being generated, as well as accept descriptive contextual text from the user. It will be appreciated that user interface 700 provides one example of such user interface data fields, but any suitable user interface data fields may be utilized.

In various implementations, user interface 700 additionally includes filter rules data field 710 which is configured to receive inputs from a user to configure a filtering rule to be applied between the first data object type and the second data object type. For example, first attribute data field 712 may be configured to receive an input identifying a first attribute, such as a particular criteria field. Moreover, second attribute data field 716 may be configured to receive an input that specifies a value associated with such criteria field. Moreover, first operator 714 may be configured to receive an input that specifies an operator to be applied based on the specified criteria field and value. In various implementations, second operator 718 is also included and may receive an input identifying an operator to be applied when multiple conditions and rules are present, as will be discussed in greater detail below.

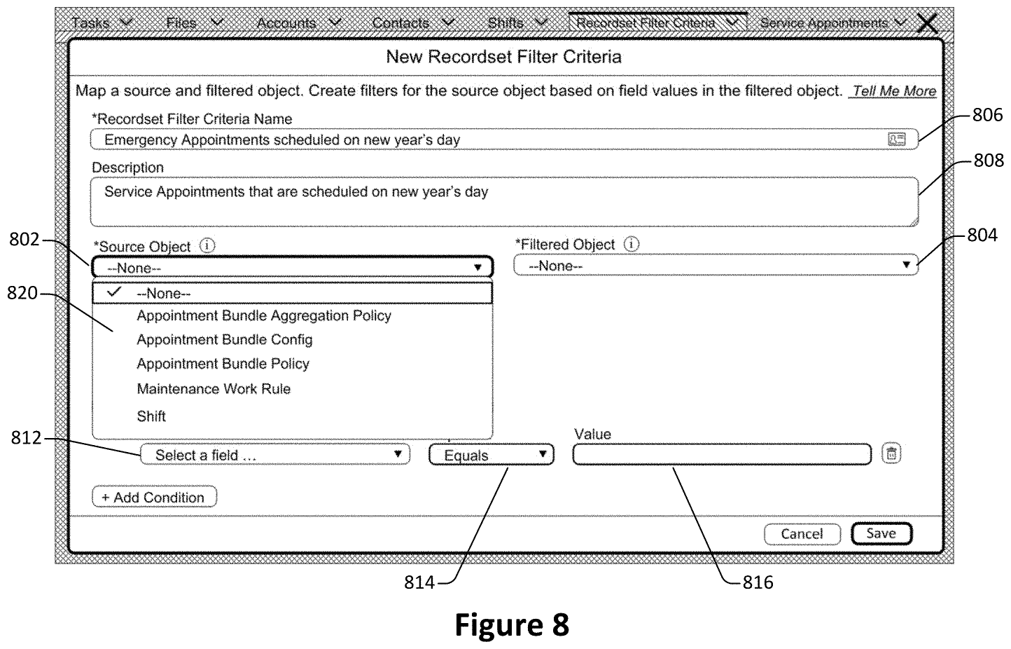

FIG. 8 illustrates another image of an example of a data filtering tool, configured in accordance with some implementations. As discussed above, a user interface, such as user interface 800, may be generated and presented to a user to receive one or more inputs used to generate filter criteria data objects and filter criteria rule data objects. As similarly discussed above, user interface 800 includes first data field 802, second data field 804, third data field 806, fourth data field 808, first attribute data field 812, first operator 814, and second attribute data field 816. User interface 800 may include additional data fields and operators as well, and some may be occluded by other user interface elements, such as data field 820 discussed in greater detail below.

As shown in user interface 800, text has been entered into third data field 806 and fourth data field 808 to provide a name and descriptive information for the filter criteria and rule being defined by the user. As also shown in user interface 800, the user has provided an input to first data field 802 and clicked on first data field 802. In response to receiving the input, user interface 800 has generated data field 820 which presents several candidate first data object types that may be selected. In one example, data field 820 is a drop-down menu that is configured to receive a selection from the user. In this way, a selection of candidate first data object types may be received.

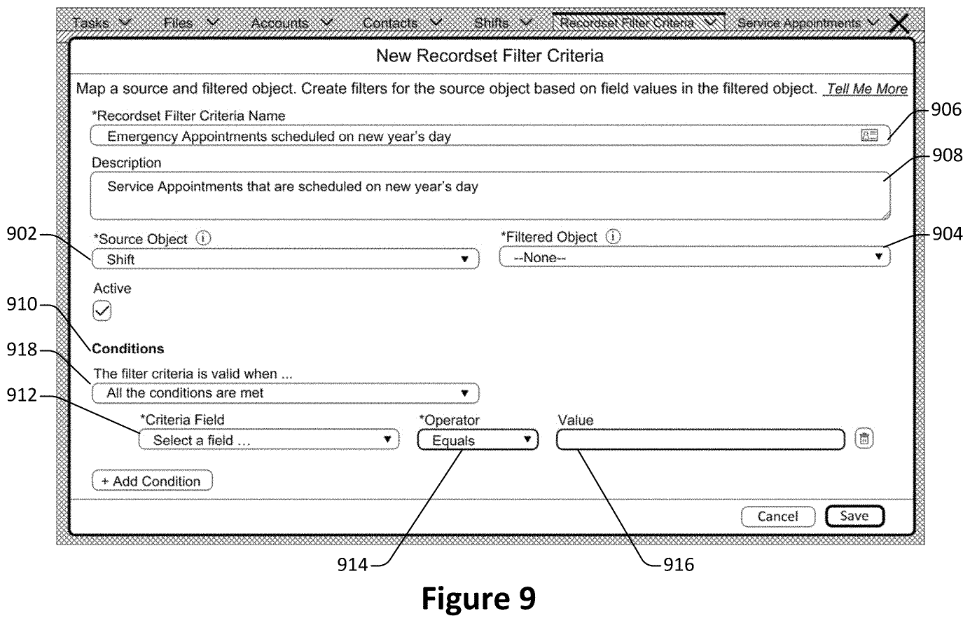

FIG. 9 illustrates yet another image of an example of a data filtering tool, configured in accordance with some implementations. As similarly discussed above, user interface 900 includes first data field 902, second data field 904, third data field 906, fourth data field 908, filter rules data field 910, first attribute data field 912, first operator 914, second attribute data field 916, and second operator 918. As shown in user interface 900, the selection of one of the candidate first data object types has been made, and is now represented in first data field 902. For example, the user has selected a source data object type of “shift”, and “Shift” is displayed in first data field 902

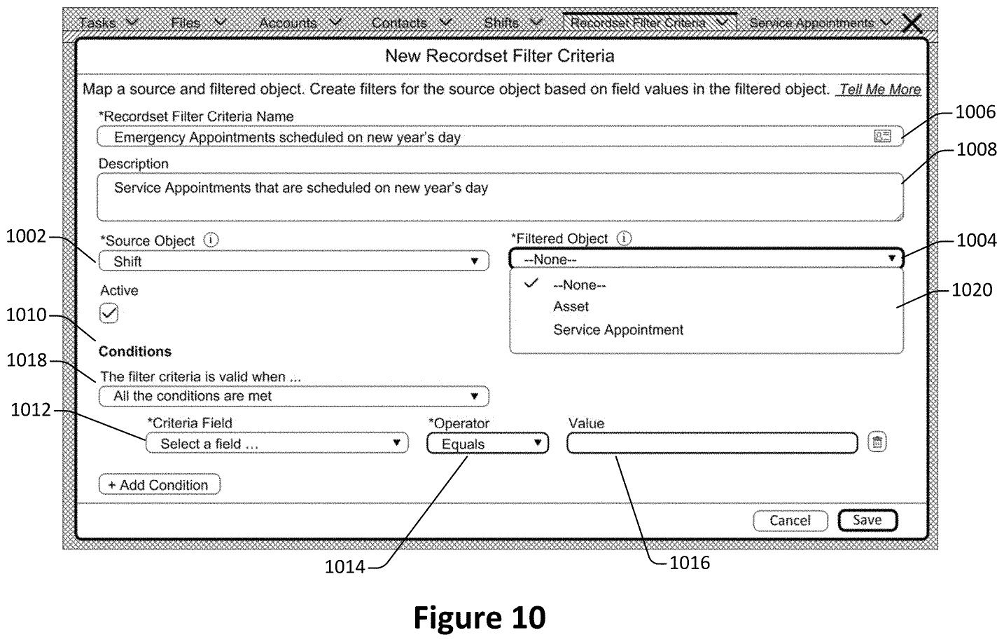

FIG. 10 illustrates an additional image of an example of a data filtering tool, configured in accordance with some implementations. As similarly discussed above, user interface 1000 includes first data field 1002, second data field 1004, third data field 1006, fourth data field 1008, filter rules data field 1010, first attribute data field 1012, first operator 1014, second attribute data field 1016, and second operator 1018. As also shown in user interface 1000, the user has provided an input to second data field 1004 and clicked on second data field 1004. In response to receiving the input, user interface 1000 has generated data field 1020 which presents several candidate second data object types that may be selected. In one example, data field 1020 is a drop-down menu that is configured to receive a selection from the user. In this way, a selection of candidate second data object types may be received.

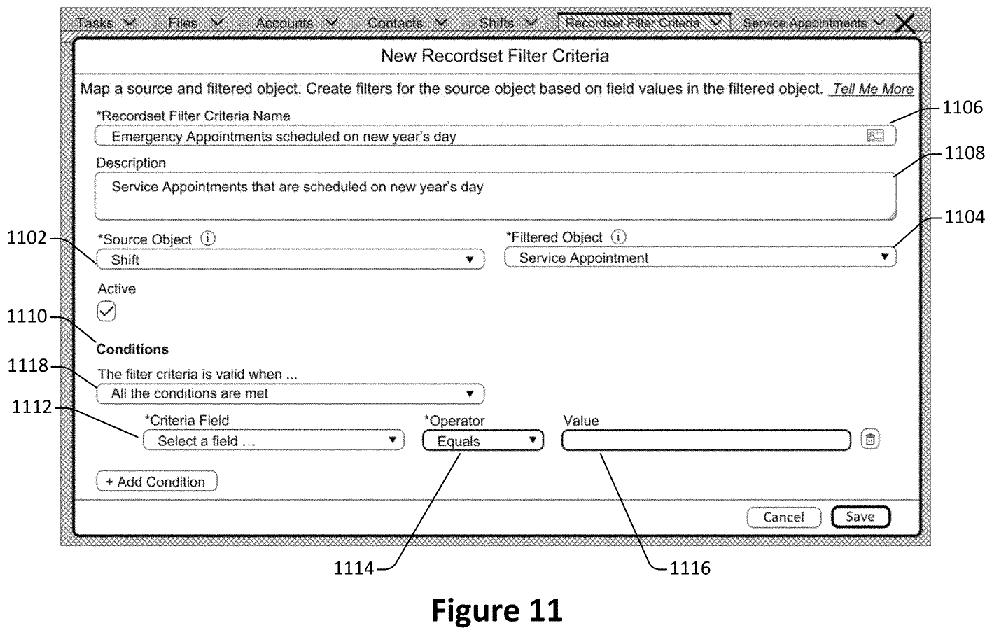

FIG. 11 illustrates another image of an example of a data filtering tool, configured in accordance with some implementations. As similarly discussed above, user interface 1100 includes first data field 1102, second data field 1104, third data field 1106, fourth data field 1108, filter rules data field 1110, first attribute data field 1112, first operator 1114, second attribute data field 1116, and second operator 1118. As shown in user interface 1100, the selection of one of the candidate second data object types has been made, and is now represented in second data field 1104. For example, the user has selected a filtered data object type of “service appointment”, and “Service Appointment” is displayed in second data field 1104.

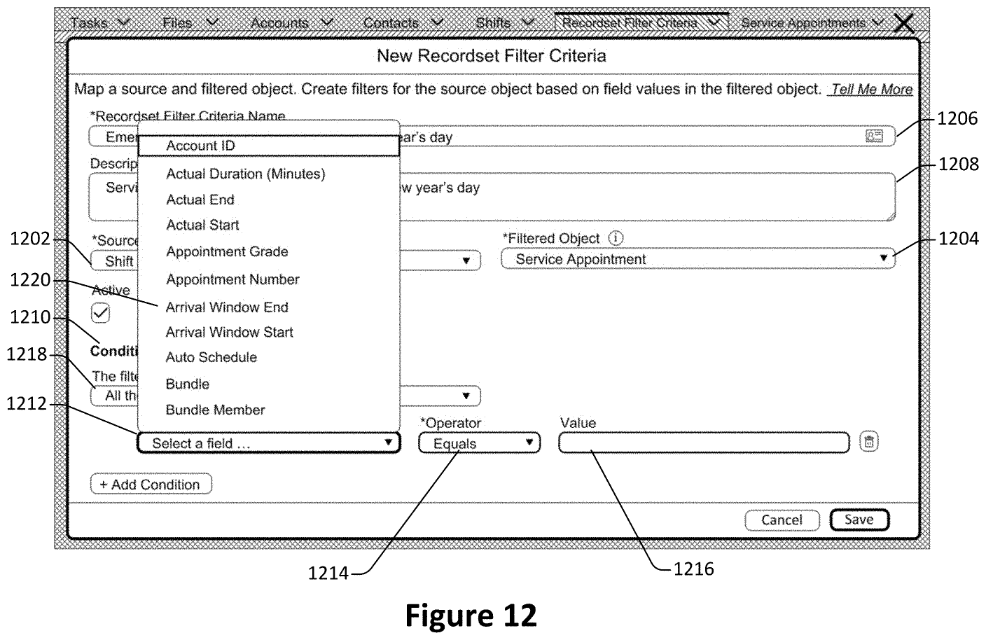

FIG. 12 illustrates yet another image of an example of a data filtering tool, configured in accordance with some implementations. As similarly discussed above, user interface 1200 includes first data field 1202, second data field 1204, third data field 1206, fourth data field 1208, filter rules data field 1210, first attribute data field 1212, first operator 1214, second attribute data field 1216, and second operator 1218. As shown in user interface 1200, the user has provided an input to first attribute data field 1212. In response to receiving the input, user interface 1200 has generated data field 1220 which presents several candidate filter criteria attributes that may be selected. In one example, data field 1220 is a drop-down menu that is configured to receive a selection from the user. Accordingly, a selection of candidate filter criteria attributes may be received.

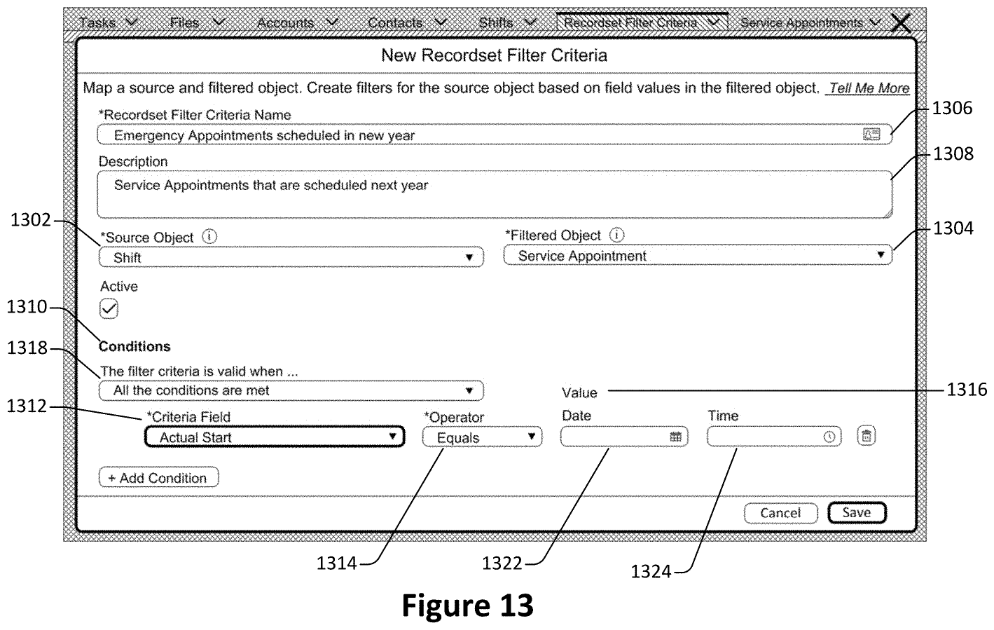

FIG. 13 illustrates an additional image of an example of a data filtering tool, configured in accordance with some implementations. As similarly discussed above, user interface 1300 includes first data field 1302, second data field 1304, third data field 1306, fourth data field 1308, filter rules data field 1310, first attribute data field 1312, first operator 1314, second attribute data field 1316, and second operator 1318. As shown in user interface 1300, the selection of one of the candidate filter criteria attributes has been made, and is now represented in first attribute data field 1312. For example, the user has selected a filter criteria attribute of “actual start”, and “Actual Start” is displayed in first attribute data field 1312. Moreover, based on the selection received for first attribute data field 1312, second attribute data field 1316 has been updated to include data fields 1322 and 1324 for a date and time respectively. Accordingly, second attribute data field 1316 has been dynamically updated in response to the input received for the selected filter criteria attribute.

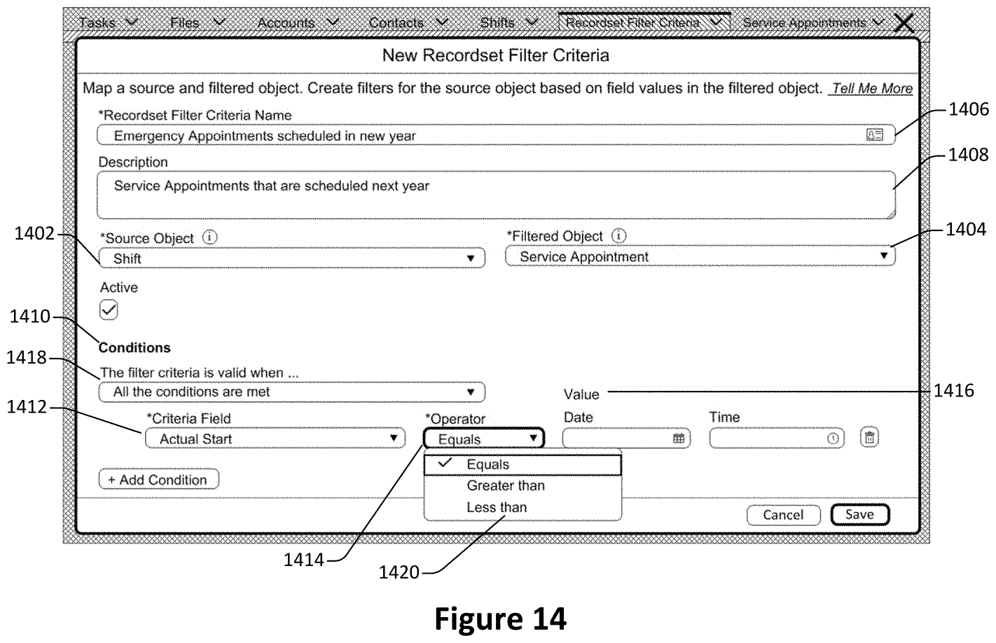

FIG. 14 illustrates another image of an example of a data filtering tool, configured in accordance with some implementations. As similarly discussed above, user interface 1400 includes first data field 1402, second data field 1404, third data field 1406, fourth data field 1408, filter rules data field 1410, first attribute data field 1412, first operator 1414, second attribute data field 1416, and second operator 1418. As also shown in user interface 1400, the user has provided an input to first operator 1414. As similarly discussed above, the input may be a mouse click or any other suitable input. In one example, the user has clicked on first operator 1414. In response to receiving the input, user interface 1400 has generated data field 1420 which presents several candidate operators that may be selected. In one example, data field 1420 is a drop-down menu that is configured to receive a selection from the user. In this way, a selection of a candidate operator may be received.

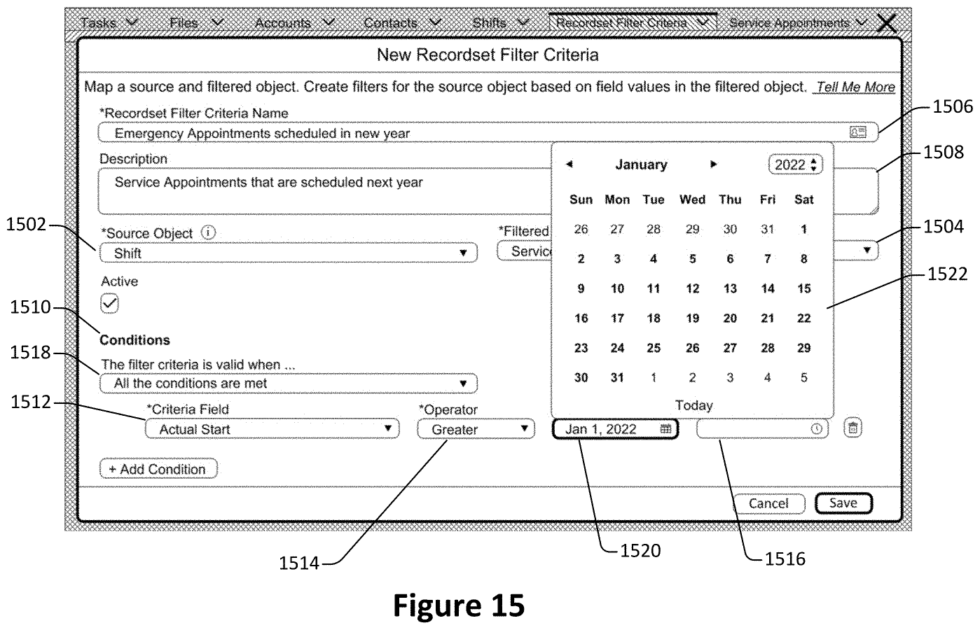

FIG. 15 illustrates an additional image of an example of a data filtering tool, configured in accordance with some implementations. As similarly discussed above, user interface 1500 includes first data field 1502, second data field 1504, third data field 1506, fourth data field 1508, filter rules data field 1510, first attribute data field 1512, first operator 1514, second attribute data field 1516, and second operator 1518. In various implementations, a selection of one of the candidate operators has been made, and is now represented in first operator 1514. In the example shown, the user has selected an operator of “greater”, and “Greater” is displayed in first operator 1514.

User interface 1500 further illustrates a user input being received at data field 1520 that has caused the generation of data field 1522. More specifically, data field 1520 is configured to receive an input, and data field 1522 is generated and displayed in response to receiving the input, and to display candidate dates available for selection. In the example shown, the candidate dates are shown in the form of an interactive calendar which the user may use to select a date.

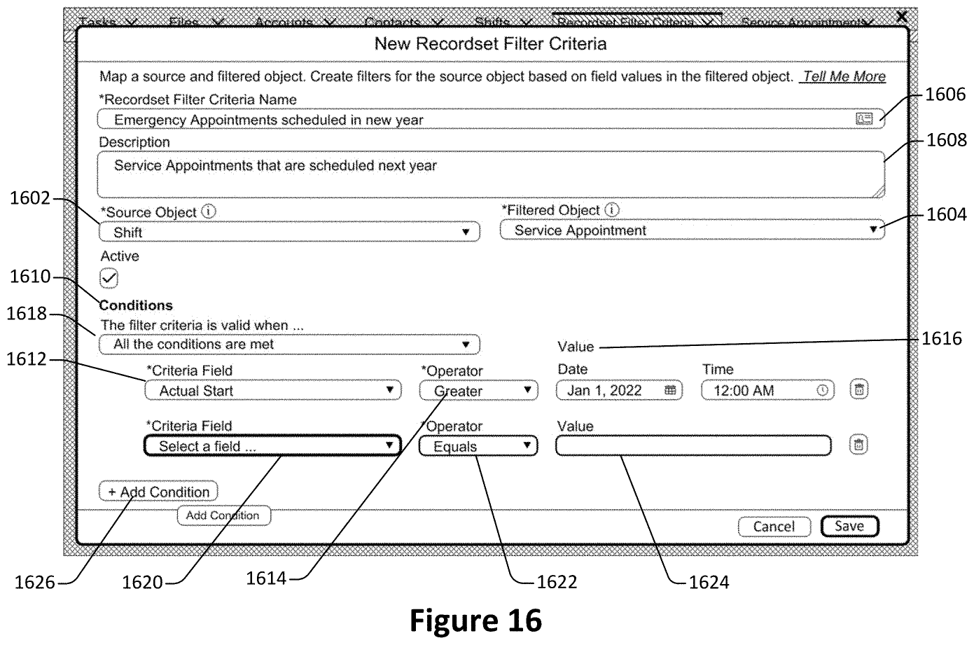

FIG. 16 illustrates another image of an example of a data filtering tool, configured in accordance with some implementations. As similarly discussed above, user interface 1600 includes first data field 1602, second data field 1604, third data field 1606, fourth data field 1608, filter rules data field 1610, first attribute data field 1612, first operator 1614, second attribute data field 1616, and second operator 1618.

User interface 1600 additionally includes third attribute data field 1620, third operator 1622, and fourth attribute data field 1624. As similarly discussed above, these user interface elements are configured to receive user inputs defining filtering criteria, as well as operators and values associated with such filtering criteria. Thus, multiple filter criteria rules may be generated and defined within a single user interface. Moreover, second operator 1618 may define logical operators to be applied to combinations of the multiple filter criteria rules. For example, an operator of “All the conditions are met” has been selected, so both of the filter criteria rules must be satisfied during a subsequent query in order for a match to be determined.

In various implementations, third attribute data field 1620, third operator 1622, and fourth attribute data field 1624 may be generated responsive to a user input. For example, the user may provide an input to data field 1626, and in response to receiving the input, third attribute data field 1620, third operator 1622, and fourth attribute data field 1624 may be generated and presented in user interface 1600.

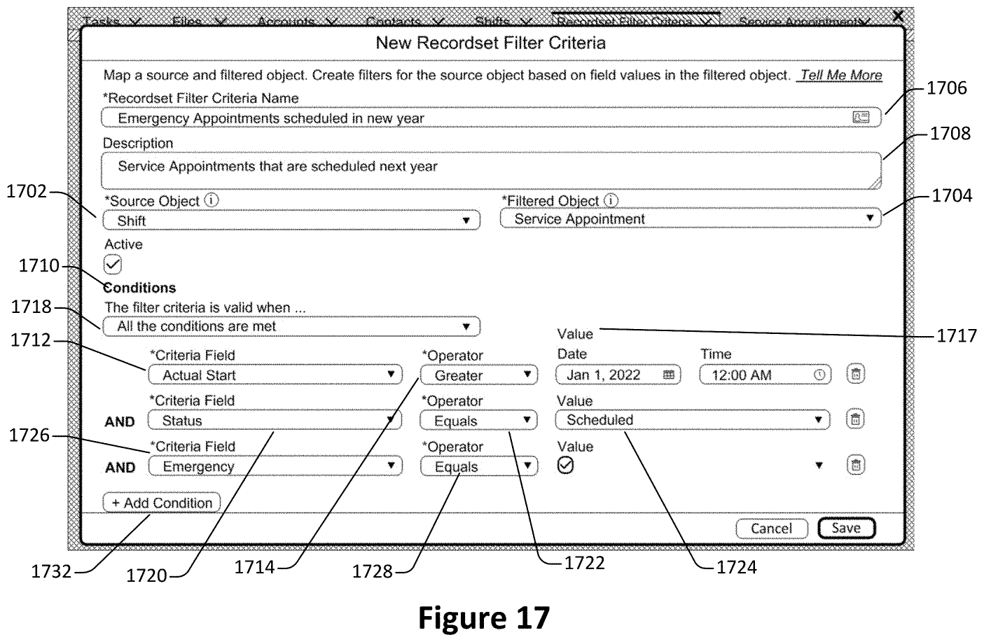

FIG. 17 illustrates yet another image of an example of a data filtering tool, configured in accordance with some implementations. As similarly discussed above, user interface 1700 includes first data field 1702, second data field 1704, third data field 1706, fourth data field 1708, filter rules data field 1710, first attribute data field 1712, first operator 1714, second attribute data field 1716, second operator 1718, third attribute data field 1720, third operator 1722, and fourth attribute data field 1724. As shown in user interface 1700, an input has been provided for both third attribute data field 1720, third operator 1722, and fourth attribute data field 1724. Moreover, additional user interface elements such as, fifth attribute data field 1726 and fourth operator 1728 have been generated in response to an additional input being provided to data field 1732. In this way, any number of additional filter criteria rules may be defined within user interface 1700 and used in combination for subsequent queries.

FIG. 18 shows a block diagram of an example of an environment 1810 that includes an on-demand database service configured in accordance with some implementations. Environment 1810 may include user systems 1812, network 1814, database system 1816, processor system 1817, application platform 1818, network interface 1820, tenant data storage 1822, tenant data 1823, system data storage 1824, system data 1825, program code 1826, process space 1828, User Interface (UI) 1830, Application Program Interface (API) 1832, PL/SOQL 1834, save routines 1836, application setup mechanism 1838, application servers 1850-1 through 1850-N, system process space 1852, tenant process spaces 1854, tenant management process space 1860, tenant storage space 1862, user storage 1864, and application metadata 1866. Some of such devices may be implemented using hardware or a combination of hardware and software and may be implemented on the same physical device or on different devices. Thus, terms such as “data processing apparatus,” “machine,” “server” and “device” as used herein are not limited to a single hardware device, but rather include any hardware and software configured to provide the described functionality.

An on-demand database service, implemented using system 1816, may be managed by a database service provider. Some services may store information from one or more tenants into tables of a common database image to form a multi-tenant database system (MTS). As used herein, each MTS could include one or more logically and/or physically connected servers distributed locally or across one or more geographic locations. Databases described herein may be implemented as single databases, distributed databases, collections of distributed databases, or any other suitable database system. A database image may include one or more database objects. A relational database management system (RDBMS) or a similar system may execute storage and retrieval of information against these objects.

In some implementations, the application platform 1818 may be a framework that allows the creation, management, and execution of applications in system 1816. Such applications may be developed by the database service provider or by users or third-party application developers accessing the service. Application platform 1818 includes an application setup mechanism 1838 that supports application developers' creation and management of applications, which may be saved as metadata into tenant data storage 1822 by save routines 1836 for execution by subscribers as one or more tenant process spaces 1854 managed by tenant management process 1860 for example. Invocations to such applications may be coded using PL/SOQL 1834 that provides a programming language style interface extension to API 1832. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes. Such system processes may manage retrieval of application metadata 1866 for a subscriber making such an invocation. Such system processes may also manage execution of application metadata 1866 as an application in a virtual machine.

In some implementations, each application server 1850 may handle requests for any user associated with any organization. A load balancing function (e.g., an F5 Big-IP load balancer) may distribute requests to the application servers 1850 based on an algorithm such as least-connections, round robin, observed response time, etc. Each application server 1850 may be configured to communicate with tenant data storage 1822 and the tenant data 1823 therein, and system data storage 1824 and the system data 1825 therein to serve requests of user systems 1812. The tenant data 1823 may be divided into individual tenant storage spaces 1862, which can be either a physical arrangement and/or a logical arrangement of data. Within each tenant storage space 1862, user storage 1864 and application metadata 1866 may be similarly allocated for each user. For example, a copy of a user's most recently used (MRU) items might be stored to user storage 1864. Similarly, a copy of MRU items for an entire tenant organization may be stored to tenant storage space 1862. A UI 1830 provides a user interface and an API 1832 provides an application programming interface to system 1816 resident processes to users and/or developers at user systems 1812.

System 1816 may implement a web-based dynamic filtering system. For example, in some implementations, system 1816 may include application servers configured to implement and execute dynamic filtering applications. The application servers may be configured to provide related data, code, forms, web pages and other information to and from user systems 1812. Additionally, the application servers may be configured to store information to, and retrieve information from a database system. Such information may include related data, objects, and/or Webpage content. With a multi-tenant system, data for multiple tenants may be stored in the same physical database object in tenant data storage 1822, however, tenant data may be arranged in the storage medium(s) of tenant data storage 1822 so that data of one tenant is kept logically separate from that of other tenants. In such a scheme, one tenant may not access another tenant's data, unless such data is expressly shared.

Several elements in the system shown in FIG. 18 include conventional, well-known elements that are explained only briefly here. For example, user system 1812 may include processor system 1812A, memory system 1812B, input system 1812C, and output system 1812D. A user system 1812 may be implemented as any computing device(s) or other data processing apparatus such as a mobile phone, laptop computer, tablet, desktop computer, or network of computing devices. User system 12 may run an internet browser allowing a user (e.g., a subscriber of an MTS) of user system 1812 to access, process and view information, pages and applications available from system 1816 over network 1814. Network 1814 may be any network or combination of networks of devices that communicate with one another, such as any one or any combination of a LAN (local area network), WAN (wide area network), wireless network, or other appropriate configuration.

The users of user systems 1812 may differ in their respective capacities, and the capacity of a particular user system 1812 to access information may be determined at least in part by “permissions” of the particular user system 1812. As discussed herein, permissions generally govern access to computing resources such as data objects, components, and other entities of a computing system, such as a dynamic filtering system and/or a CRM database system. “Permission sets” generally refer to groups of permissions that may be assigned to users of such a computing environment. For instance, the assignments of users and permission sets may be stored in one or more databases of System 1816. Thus, users may receive permission to access certain resources. A permission server in an on-demand database service environment can store criteria data regarding the types of users and permission sets to assign to each other. For example, a computing device can provide to the server data indicating an attribute of a user (e.g., geographic location, industry, role, level of experience, etc.) and particular permissions to be assigned to the users fitting the attributes. Permission sets meeting the criteria may be selected and assigned to the users. Moreover, permissions may appear in multiple permission sets. In this way, the users can gain access to the components of a system.

In some an on-demand database service environments, an Application Programming Interface (API) may be configured to expose a collection of permissions and their assignments to users through appropriate network-based services and architectures, for instance, using Simple Object Access Protocol (SOAP) Web Service and Representational State Transfer (REST) APIs.

In some implementations, a permission set may be presented to an administrator as a container of permissions. However, each permission in such a permission set may reside in a separate API object exposed in a shared API that has a child-parent relationship with the same permission set object. This allows a given permission set to scale to millions of permissions for a user while allowing a developer to take advantage of joins across the API objects to query, insert, update, and delete any permission across the millions of possible choices. This makes the API highly scalable, reliable, and efficient for developers to use.

In some implementations, a permission set API constructed using the techniques disclosed herein can provide scalable, reliable, and efficient mechanisms for a developer to create tools that manage a user's permissions across various sets of access controls and across types of users. Administrators who use this tooling can effectively reduce their time managing a user's rights, integrate with external systems, and report on rights for auditing and troubleshooting purposes. By way of example, different users may have different capabilities with regard to accessing and modifying application and database information, depending on a user's security or permission level, also called authorization. In systems with a hierarchical role model, users at one permission level may have access to applications, data, and database information accessible by a lower permission level user, but may not have access to certain applications, database information, and data accessible by a user at a higher permission level.

As discussed above, system 1816 may provide on-demand database service to user systems 1812 using an MTS arrangement. By way of example, one tenant organization may be a company that employs a sales force where each salesperson uses system 1816 to manage their sales process. Thus, a user in such an organization may maintain contact data, leads data, customer follow-up data, performance data, goals and progress data, etc., all applicable to that user's personal sales process (e.g., in tenant data storage 1822). In this arrangement, a user may manage his or her sales efforts and cycles from a variety of devices, since relevant data and applications to interact with (e.g., access, view, modify, report, transmit, calculate, etc.) such data may be maintained and accessed by any user system 1812 having network access.

When implemented in an MTS arrangement, system 1816 may separate and share data between users and at the organization-level in a variety of manners. For example, for certain types of data each user's data might be separate from other users' data regardless of the organization employing such users. Other data may be organization-wide data, which is shared or accessible by several users or potentially all users form a given tenant organization. Thus, some data structures managed by system 1816 may be allocated at the tenant level while other data structures might be managed at the user level. Because an MTS might support multiple tenants including possible competitors, the MTS may have security protocols that keep data, applications, and application use separate. In addition to user-specific data and tenant-specific data, system 1816 may also maintain system-level data usable by multiple tenants or other data. Such system-level data may include industry reports, news, postings, and the like that are sharable between tenant organizations.

In some implementations, user systems 1812 may be client systems communicating with application servers 1850 to request and update system-level and tenant-level data from system 1816. By way of example, user systems 1812 may send one or more queries requesting data of a database maintained in tenant data storage 1822 and/or system data storage 1824. An application server 1850 of system 1816 may automatically generate one or more SQL statements (e.g., one or more SQL queries) that are designed to access the requested data. System data storage 1824 may generate query plans to access the requested data from the database.

The database systems described herein may be used for a variety of database applications. By way of example, each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some implementations, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in an MTS. In certain implementations, for example, all custom entity data rows may be stored in a single multi-tenant physical table, which may contain multiple logical tables per organization. It may be transparent to customers that their multiple “tables” are in fact stored in one large table or that their data may be stored in the same table as the data of other customers.

FIG. 19A shows a system diagram of an example of architectural components of an on-demand database service environment 1900, configured in accordance with some implementations. A client machine located in the cloud 1904 may communicate with the on-demand database service environment via one or more edge routers 1908 and 1912. A client machine may include any of the examples of user systems ?12 described above. The edge routers 1908 and 1912 may communicate with one or more core switches 1920 and 1924 via firewall 1916. The core switches may communicate with a load balancer 1928, which may distribute server load over different pods, such as the pods 1940 and 1944 by communication via pod switches 1932 and 1936. The pods 1940 and 1944, which may each include one or more servers and/or other computing resources, may perform data processing and other operations used to provide on-demand services. Components of the environment may communicate with a database storage 1956 via a database firewall 1948 and a database switch 1952.

Accessing an on-demand database service environment may involve communications transmitted among a variety of different components. The environment 1900 is a simplified representation of an actual on-demand database service environment. For example, some implementations of an on-demand database service environment may include anywhere from one to many devices of each type. Additionally, an on-demand database service environment need not include each device shown, or may include additional devices not shown, in FIGS. 19A and 19B.

The cloud 1904 refers to any suitable data network or combination of data networks, which may include the Internet. Client machines located in the cloud 1904 may communicate with the on-demand database service environment 1900 to access services provided by the on-demand database service environment 1900. By way of example, client machines may access the on-demand database service environment 1900 to retrieve, store, edit, and/or process data object information or associated information.

In some implementations, the edge routers 1908 and 1912 route packets between the cloud 1904 and other components of the on-demand database service environment 1900. The edge routers 1908 and 1912 may employ the Border Gateway Protocol (BGP). The edge routers 1908 and 1912 may maintain a table of IP networks or ‘prefixes’, which designate network reachability among autonomous systems on the internet.

In one or more implementations, the firewall 1916 may protect the inner components of the environment 1900 from internet traffic. The firewall 1916 may block, permit, or deny access to the inner components of the on-demand database service environment 1900 based upon a set of rules and/or other criteria. The firewall 1916 may act as one or more of a packet filter, an application gateway, a stateful filter, a proxy server, or any other type of firewall.

In some implementations, the core switches 1920 and 1924 may be high-capacity switches that transfer packets within the environment 1900. The core switches 1920 and 1924 may be configured as network bridges that quickly route data between different components within the on-demand database service environment. The use of two or more core switches 1920 and 1924 may provide redundancy and/or reduced latency.

In some implementations, communication between the pods 1940 and 1944 may be conducted via the pod switches 1932 and 1936. The pod switches 1932 and 1936 may facilitate communication between the pods 1940 and 1944 and client machines, for example via core switches 1920 and 1924. Also or alternatively, the pod switches 1932 and 1936 may facilitate communication between the pods 1940 and 1944 and the database storage 1956. The load balancer 1928 may distribute workload between the pods, which may assist in improving the use of resources, increasing throughput, reducing response times, and/or reducing overhead. The load balancer 1928 may include multilayer switches to analyze and forward traffic.

In some implementations, access to the database storage 1956 may be guarded by a database firewall 1948, which may act as a computer application firewall operating at the database application layer of a protocol stack. The database firewall 1948 may protect the database storage 1956 from application attacks such as structure query language (SQL) injection, database rootkits, and unauthorized information disclosure. The database firewall 1948 may include a host using one or more forms of reverse proxy services to proxy traffic before passing it to a gateway router and/or may inspect the contents of database traffic and block certain content or database requests. The database firewall 1948 may work on the SQL application level atop the TCP/IP stack, managing applications' connection to the database or SQL management interfaces as well as intercepting and enforcing packets traveling to or from a database network or application interface.

In some implementations, the database storage 1956 may be an on-demand database system shared by many different organizations. The on-demand database service may employ a single-tenant approach, a multi-tenant approach, a virtualized approach, or any other type of database approach. Communication with the database storage 1956 may be conducted via the database switch 1952. The database storage 1956 may include various software components for handling database queries. Accordingly, the database switch 1952 may direct database queries transmitted by other components of the environment (e.g., the pods 1940 and 1944) to the correct components within the database storage 1956.

FIG. 19B shows a system diagram further illustrating an example of architectural components of an on-demand database service environment, in accordance with some implementations. The pod 1944 may be used to render services to user(s) of the on-demand database service environment 1900. The pod 1944 may include one or more content batch servers 1964, content search servers 1968, query servers 1982, file servers 1986, access control system (ACS) servers 1980, batch servers 1984, and app servers 1988. Also, the pod 1944 may include database instances 1990, quick file systems (QFS) 1992, and indexers 1994. Some or all communication between the servers in the pod 1944 may be transmitted via the switch 1936.

In some implementations, the app servers 1988 may include a framework dedicated to the execution of procedures (e.g., programs, routines, scripts) for supporting the construction of applications provided by the on-demand database service environment 1900 via the pod 1944. One or more instances of the app server 1988 may be configured to execute all or a portion of the operations of the services described herein.

In some implementations, as discussed above, the pod 1944 may include one or more database instances 1990. A database instance 1990 may be configured as an MTS in which different organizations share access to the same database, using the techniques described above. Database information may be transmitted to the indexer 1994, which may provide an index of information available in the database 1990 to file servers 1986. The QFS 1992 or other suitable filesystem may serve as a rapid-access file system for storing and accessing information available within the pod 1944. The QFS 1992 may support volume management capabilities, allowing many disks to be grouped together into a file system. The QFS 1992 may communicate with the database instances 1990, content search servers 1968 and/or indexers 1994 to identify, retrieve, move, and/or update data stored in the network file systems (NFS) 1996 and/or other storage systems.

In some implementations, one or more query servers 1982 may communicate with the NFS 1996 to retrieve and/or update information stored outside of the pod 1944. The NFS 1996 may allow servers located in the pod 1944 to access information over a network in a manner similar to how local storage is accessed. Queries from the query servers 1922 may be transmitted to the NFS 1996 via the load balancer 1928, which may distribute resource requests over various resources available in the on-demand database service environment 1900. The NFS 1996 may also communicate with the QFS 1992 to update the information stored on the NFS 1996 and/or to provide information to the QFS 1992 for use by servers located within the pod 1944.

In some implementations, the content batch servers 1964 may handle requests internal to the pod 1944. These requests may be long-running and/or not tied to a particular customer, such as requests related to log mining, cleanup work, and maintenance tasks. The content search servers 1968 may provide query and indexer functions such as functions allowing users to search through content stored in the on-demand database service environment 1900. The file servers 1986 may manage requests for information stored in the file storage 1998, which may store information such as documents, images, basic large objects (BLOBS), etc. The query servers 1982 may be used to retrieve information from one or more file systems. For example, the query system 1982 may receive requests for information from the app servers 1988 and then transmit information queries to the NFS 1996 located outside the pod 1944. The ACS servers 1980 may control access to data, hardware resources, or software resources called upon to render services provided by the pod 1944. The batch servers 1984 may process batch jobs, which are used to run tasks at specified times. Thus, the batch servers 1984 may transmit instructions to other servers, such as the app servers 1988, to trigger the batch jobs.

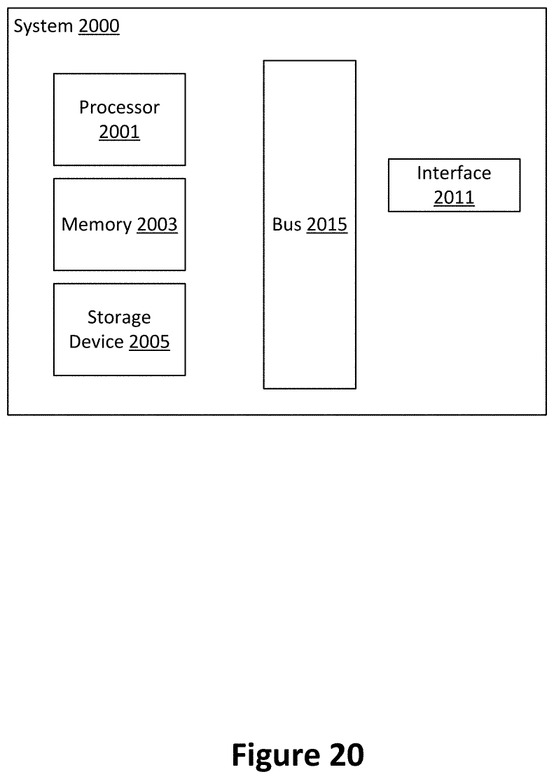

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of present disclosure. FIG. 20 illustrates one example of a computing device. According to various implementations, a system 2000 suitable for implementing implementations described herein includes a processor 2001, a memory module 2003, a storage device 2005, an interface 2011, and a bus 2015 (e.g., a PCI bus or other interconnection fabric.) System 2000 may operate as variety of devices such as an application server, a database server, or any other device or service described herein. Although a particular configuration is described, a variety of alternative configurations are possible. The processor 2001 may perform operations such as those described herein. Instructions for performing such operations may be embodied in the memory 2003, on one or more non-transitory computer readable media, or on some other storage device. Various specially configured devices can also be used in place of or in addition to the processor 2001. The interface 2011 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Apex, Java, Python, C++, C, HTML, any other markup language, JavaScript, ActiveX, VBScript, or Perl. Examples of computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A computer-readable medium may be any combination of such storage devices.

In the foregoing specification, various techniques and mechanisms may have been described in singular form for clarity. However, it should be noted that some implementations include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities. In the foregoing specification, reference was made in detail to specific implementations including one or more of the best modes contemplated by the inventors. While various implementations have been described herein, it should be understood that they have been presented by way of example only, and not limitation. For example, some techniques and mechanisms are described herein in the context of on-demand computing environments that include MTSs. However, the techniques of disclosed herein apply to a wide variety of computing environments. Particular implementations may be implemented without some or all of the specific details described herein. In other instances, well known process operations have not been described in detail in order to avoid unnecessarily obscuring the disclosed techniques. Accordingly, the breadth and scope of the present application should not be limited by any of the implementations described herein, but should be defined only in accordance with the claims and their equivalents.

What is claimed is:

1. A computing platform implemented using a server system, the computing platform being configurable to cause:
identifying a first data object type of a computing platform, the first data object type identifying a plurality of first data objects being included in a data model of an application hosted by the computing platform;
identifying a second data object type of the computing platform, the second data object type identifying a plurality of second data objects included in the data model, and the identifying of the second data object type defining a relationship between the second data object type and the first data object type; and
generating a filter rule associated with the second data object type, the filter rule defining which of the plurality of second data objects may be associated with the plurality of first data objects, the filter rule being defined based, at least in part, on at least some of a plurality of attributes of the second data object type.

2. The computing platform of claim 1, wherein the generating of the filter rule further comprises:
storing one or more identifiers representing the first data object type and the second data object type as a filter criteria data object; and
storing a plurality of filter criteria and at least one operator as a filter criteria rule data object.

3. The computing platform of claim 2, wherein the plurality of filter criteria is determined based on an input received from a user.

4. The computing platform of claim 3, wherein the input is received from the user via a user interface.

5. The computing platform of claim 2, wherein the filter criteria rule data object is configured to have a data dependency on the filter criteria data object.

6. The computing platform of claim 2 further comprising:
transmitting the filter criteria data object and the filter criteria rule data object to a query engine.

7. The computing platform of claim 6 further comprising:
executing, via the query engine, a query on a database system based, at least in part, on the filter criteria data object and the filter criteria rule data object; and
generating a result object that identifies a plurality of second data objects matching the filter criteria data object and the filter criteria rule data object.

8. The computing platform of claim 7, wherein the database system is a multi-tenant database system.

9. The computing platform of claim 1, wherein the data model is included in an on-demand distributed software application.

10. A method comprising:
identifying a first data object type of a computing platform, the first data object type identifying a plurality of first data objects being included in a data model of an application hosted by the computing platform;
identifying a second data object type of the computing platform, the second data object type identifying a plurality of second data objects included in the data model, and the identifying of the second data object type defining a relationship between the second data object type and the first data object type; and
generating a filter rule associated with the second data object type, the filter rule defining which of the plurality of second data objects may be associated with the plurality of first data objects, the filter rule being defined based, at least in part, on at least some of a plurality of attributes of the second data object type.

11. The method of claim 10 wherein the generating of the filter rule further comprises:
storing one or more identifiers representing the first data object type and the second data object type as a filter criteria data object; and
storing a plurality of filter criteria and at least one operator as a filter criteria rule data object.

12. The method of claim 11, wherein the plurality of filter criteria is determined based on an input received from a user, and wherein the input is received from the user via a user interface.

13. The method of claim 11, wherein the filter criteria rule data object is configured to have a data dependency on the filter criteria data object.

14. The method of claim 11 further comprising:
transmitting the filter criteria data object and the filter criteria rule data object to a query engine.

15. The method of claim 14 further comprising:
executing, via the query engine, a query on a database system based, at least in part, on the filter criteria data object and the filter criteria rule data object; and
generating a result object that identifies a plurality of second data objects matching the filter criteria data object and the filter criteria rule data object.

16. The method of claim 15, wherein the database system is a multi-tenant database system.

17. A computer program product comprising non-transitory computer-readable program code capable of being executed by one or more processors when retrieved from a non-transitory computer-readable medium, the program code comprising instructions configurable to cause the one or more processors to perform a method comprising: identifying a first data object type of a computing platform, the first data object type identifying a plurality of first data objects being included in a data model of an application hosted by the computing platform;
identifying a second data object type of the computing platform, the second data object type identifying a plurality of second data objects included in the data model, and the identifying of the second data object type defining a relationship between the second data object type and the first data object type; and
generating a filter rule associated with the second data object type, the filter rule defining which of the plurality of second data objects may be associated with the plurality of first data objects, the filter rule being defined based, at least in part, on at least some of a plurality of attributes of the second data object type.

18. The computer program product recited in claim 17, wherein the generating of the filter rule further comprises:
storing one or more identifiers representing the first data object type and the second data object type as a filter criteria data object; and
storing a plurality of filter criteria and at least one operator as a filter criteria rule data object.

19. The computer program product recited in claim 18, wherein the plurality of filter criteria is determined based on an input received from a user, and wherein the input is received from the user via a user interface.

20. The computer program product recited in claim 18, wherein the one or more processors are further configured to perform:
transmitting the filter criteria data object and the filter criteria rule data object to a query engine;
executing, via the query engine, a query on a database system based, at least in part, on the filter criteria data object and the filter criteria rule data object; and
generating a result object that identifies a plurality of second data objects matching the filter criteria data object and the filter criteria rule data object.
